(19) United States
(12) Patent Application Publication
(10) Pub. No.: US 2016/0092835 A1
(43) Pub. Date: Mar. 31, 2016

(54) ZONE CLEANING SYSTEM, APPARATUS AND ASSOCIATED METHOD OF INVENTORY MANAGEMENT

(71) Applicant: Cintas Corporation, Cincinnati, OH (US)

(72) Inventors: David F. Collette, Cincinnati, OH (US); Richard R. Bing, West Chester, OH (US); Tricia Hubbard, Dayton, OH (US)

(73) Assignee: Cintas Corporation, Cincinnati, OH (US)

(21) Appl. No.: 14/934,286

(22) Filed: Nov. 6, 2015

Related U.S. Application Data
(62) Division of application No. 13/799,041, filed on Mar. 13, 2013.
(60) Provisional application No. 61/700,915, filed on Sep. 14, 2012.

(51) Int. Cl. G06Q 10/08; G06K 7/10; A47L 13/24

(52) U.S. Cl. CPC G06Q 10/087; A47L 13/24; G06K 7/10564

(57) ABSTRACT

A restaurant cleaning mop includes a color label on the surface of the mop handle to identify the area of the restaurant in which the cleaning mop is to be utilized. The mop handle is detachable from a mop head and the handle bears the indicia. Moreover, since the indicia is provided on the detachable handle, the non-differentiated mop head can be easily replaced as needed and the mop handle remains in the designated area while the mop head is replaced. In another aspect, this invention is directed to an inventory management scheme in which a first detachable part of a cleaning tool, such as a mop handle, bears coded indicia to indicate a particular zone or area of a facility in which the tool is to be used.

This is a divisional of U.S. patent application Ser. No. 13/799,041, filed Mar. 13, 2013, which claimed the benefit of U.S. Provisional Patent Application Ser. No. 61/700,915, filed on Sep. 14, 2012. Each of these prior applications is hereby incorporated by reference in its entirety herein.

### BACKGROUND OF THE INVENTION

This invention relates to cleaning supplies. More particularly, this invention is directed to a cleaning tool having indicia to identify the area in which the cleaning tool is to be utilized, and a method of managing an inventory of such tools.

For a variety of reasons, it has been difficult for many individuals to easily identify and use the proper tool drawn from a collection of similar tools for use on a specific task. Mops are well-known cleaning devices used for cleaning hard floors and other surfaces. Mops typically include yarn, looped yarn, textiles, microfiber textiles, paper products, or other similar materials that are useful for picking up and retaining dust, dirt, and other small particles from a surface. Several types of mops are available, including dry mops and wet mops. For example, a dry mop can be used to remove dust and dirt from a floor surface. And, a wet mop can be moistened with a detergent solution and then used to clean a floor surface. In addition, mops may be reusable or disposable. For example, once a mop has been used and has picked up a quantity of dust and dirt, it may be laundered or cleaned in order to remove the dust and dirt. Then, the mop may be reused.

Hospitals, shopping malls, schools, restaurants and other facilities may use a great number of mops as part of their hard floor maintenance routines. For example, to avoid cross-contamination between patient rooms in a hospital, a new mop might be used to clean each individual hospital room. In addition, a shopping mall with expansive floor surfaces might also use several mops for a single cleaning. Thus, some cleaning circumstances may require a facility to maintain a substantial inventory of mops. Often, reusable mops are used in these circumstances, and significant time, effort, and expense goes into maintaining the mop inventory.

In particular, a bulk quantity of clean mops is typically initially delivered to the facility's janitorial department. The bulk quantity of clean mops is stored for subsequent use, such as in a janitorial storage location. As clean mops are needed, they are taken from the storage location and distributed for use by janitorial personnel, through which use they become dirty mops. Janitorial personnel might take several clean mops during each work shift, and deposit dirty mops in an appropriate receptacle, such as a dirty mop bin. Dirty mops accumulate in the dirty mop bin until they are taken for cleaning. At a cleaning location, the dirty mops are laundered, vacuumed, or otherwise cleaned and prepared for return to the facility's janitorial department, where clean mops are stored and used, as discussed above. In some circumstances, a third-party vendor delivers clean mops to a facility and takes away dirty mops for cleaning.

An inventory of mops for a single facility can include many, many mops. As part of managing such a large inventory, records are often kept about the number of mops, such as, for example, the number of clean mops delivered to the facility, the number of clean mops maintained in storage, the number of mops distributed to janitorial personnel during a work shift, and the number of dirty mops recovered from a dirty mop bin. Manual counting of mops is a time-consuming process and prone to counting errors, especially when large numbers of mops are concerned. In addition, manual counting of dirty mops may be seen as undesirable work. However, understanding the number of mops in the mop inventory remains an important consideration for a janitorial department, or for a vendor that supplies the mops to the janitorial department.

This problem is especially evident in the restaurant industry. As previously noted, a mop is a common tool used in the restaurant industry. However, for hygienic reasons, different mops should be used for different tasks and different areas within the restaurant. For example, a specific mop should be used to clean the restrooms; other mops are used for cleaning the dining area, while still other mops are used in the kitchen area. This practice of differentiating clean tools for different environments minimizes and avoids cross-contamination among and between the different environments. However, for too many employees, there is no easy way to differentiate which mop is to be used in which area of the restaurant. Additionally, many employees of the restaurant may not be able to read a label or easily understand which mop should be used in a specific area. The supervisors of these employees, although overseeing the employees, also may not be able to easily identify which mop is being used by the employee. Thus, it is often difficult for employees, as well as supervisors, to easily identify the proper mop for the proper task in the restaurant.

In various industries, there are numerous examples where labeling and coding techniques have been used to distinguish selected tools for use on specific tasks. For example, in the transportation industry, color-coding has been used to identify the container for various goods. For example, hazardous cargo is sometimes identified by a series of red stripes displayed on the outer surface of a container holding the hazardous cargo. In other industries, internationally recognized symbols have been used to convey information about particular products. For example, the familiar “skull and cross bones” has been used to identify poisonous materials. However, for tools such as mops in a restaurant, international symbols may not be well recognized and may become obscured by grease or dirt. In addition, it may be inconvenient to manipulate a mop to locate an international symbol each time the mop is going to be used.

While the prior art discloses the use of color coding to identify various goods and tools in various industries, a tool supplier to the industry participants is typically required to stock not only each of the unique tools to be utilized in the restaurant, for example, but also must stock each tool in a variety of colors or indicia, each of which is designated for use in a particular zone or area of the restaurant. Such a requirement significantly multiplies the stocking, inventory and logistical problems for the supplier as well as the restaurant or other business as the end user of multiple differentiated or coded tools, mops or the like. These types of inventory demands and issues may lead a supplier or business such as a restaurant to avoid the best practice of differentiating cleaning tools for different zones or areas of the restaurants. This may lead to the problems of cross-contamination and ineffective cleaning in the various zones.

Thus, it would be a distinct advantage to have a cleaning mop that identifies the area of the restaurant where each mop is to be used, even when various employees using the mops may be illiterate or may speak and read different languages without presenting issues and problems for the supplier and multiplying stocking requirements for and inventory of the mops or other tools.

### SUMMARY OF THE INVENTION

According to one aspect of this invention, a cleaning tool such as a mop includes a color label on the surface of the mop handle to identify the area of the restaurant in which the cleaning mop is to be utilized. Optionally, the mop may include an international icon, a tactile label, and a label in a plurality of languages or other indicia identifying the area where the mop is to be utilized.

In another aspect, this invention is directed to a restaurant cleaning mop that includes a handle detachable from a mop head and the handle bears the indicia to identify the area of the restaurant in which the cleaning mop is to be utilized. Moreover, since the indicia is provided on the detachable handle, the non-differentiated mop head can be easily replaced as needed and the mop handle remains in the designated area while the mop head is replaced. As such, the supplier and user of mop heads only need to keep an inventory of non-differentiated mop heads and not a supply for each coded zone of the restaurant.

In yet another aspect, this invention is directed to a restaurant cleaning mop utilized to clean in one of a plurality of areas in a restaurant. The mop includes a mop head selectively attached to a mop handle. The cleaning mop handle also includes a color label or other indicia on the surface of the mop handle to identify the area of the restaurant in which the cleaning mop is to be utilized. The label has a configuration and size that are operable to be readily recognized from a distance by an individual supervising an employee using the mop.

In yet another aspect, this invention is directed to an inventory management scheme in which a first detachable part of a cleaning tool, such as a mop handle, bears coded indicia to indicate a particular zone or area of a facility in which the tool is to be used. Another part of the tool, such as a detachable mop head, is not coded or differentiated relative to multiple other such components, each of which is compatible with the first detachable component. In this manner, the inventory and supply requirements are simplified and streamlined while still providing for zone restricted cleaning operations to avoid cross-contamination.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of an exemplary mop bearing an assigned zone cleaning indicia according to one aspect of this invention;

FIG. 2 is a schematic view of an exemplary restaurant floor plan demonstrating a number of different zones and associated color indicia according to one aspect of this invention;

FIGS. 3A-3E are indicia coordinated with respective zones in the environment of FIG. 2; and

FIG. 4 is a perspective view of a combination of a mop handle and multiple mop heads interchangeably connectable to the mop handle according to one aspect of this invention.

### DETAILED DESCRIPTION OF THE INVENTION

A cleaning tool 10 according to one aspect of this invention is a cleaning mop for a restaurant, and a system and method for maintaining the required inventory of such mops 10 is disclosed according to other aspects of this invention. In many industries, there are situations where many specialized tools or goods must be used for specific tasks. Many problems arise with employees identifying and understanding which tools should be used for specific tasks. In many instances, these problems are exacerbated by employees who cannot read, do not understand the language in which labels may be written, or are unable to distinguish colors (i.e., color blind). While the invention in one embodiment is described herein in a restaurant setting, it is not limited to such a setting and is readily utilized in a variety of other settings, including hotels, healthcare facilities (long-term care, aging in place, nursing homes, etc.), educational institutions (elementary, secondary, post-secondary, day-care), convenience stores, gas stations and office buildings as a few examples.

The restaurant industry is one area where this particular problem is especially acute. One such example can be seen in the utilization of cleaning tools 10. For example, a mop or rag that is used to clean a restroom should not be used to mop the customer areas or clean the kitchen. Therefore, to provide a simple method of ensuring that an employee utilizes the proper mop 10 for each particular task, each mop 10 is coded or differentiated with indicia 12 to provide easy identification of the proper tool for the proper task. While the invention is shown and described herein with respect to mops for use in a restaurant, one of ordinary skill in the art will appreciate that the various aspects of this invention are applicable to other tools, environments, industries and applications within the scope of this invention.

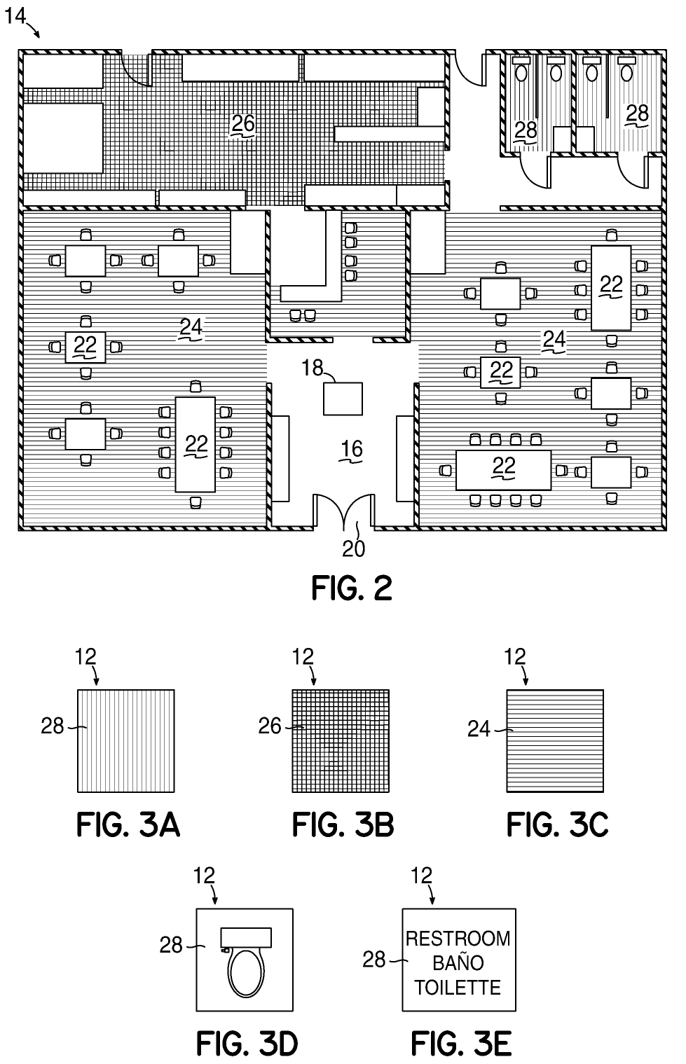

FIG. 2 is a schematic view of a floor plan 14 of an exemplary environment, such as a restaurant, in which this invention may be utilized. The restaurant environment 14 includes a number of different areas or zones as is well known. For example, the restaurant according to the exemplary floor plan 14 shown in FIG. 2 includes a welcome or reception area or zone 16 in which a hostess stand 18 is typically located for greeting customers entering the restaurant through a main doorway 20. The restaurant 14 also includes dining tables 22 in various dining areas of zone 24 of the restaurant 14 as shown in the exemplary floor plan of FIG. 2. Naturally, the restaurant 14 includes a kitchen area 26 or zone differentiated from the other zones and dedicated to the preparation and presentation of food. Moreover, restaurants and many other environments typically include bathroom or restroom facilities for the convenience of the customers and other personnel and the restrooms are a distinct zone 28. These and other areas or zones of a typical environment, including a restaurant, may be included and each zone or area typically has various and specific cleaning requirements for proper hygiene and sanitation. As previously discussed, the utilization of various cleaning tools in and across the various areas or zones 16, 24, 26, 28 of the environment or restaurant 14 typically leads to cross-contamination and is considered poor practice. Therefore, each area or zone 16, 24, 26, 28 may be assigned a unique indicator, such as a color, which may be associated with indicia 12 on mops 10 to be used in one or more of areas or zones 16, 24, 26, 28.

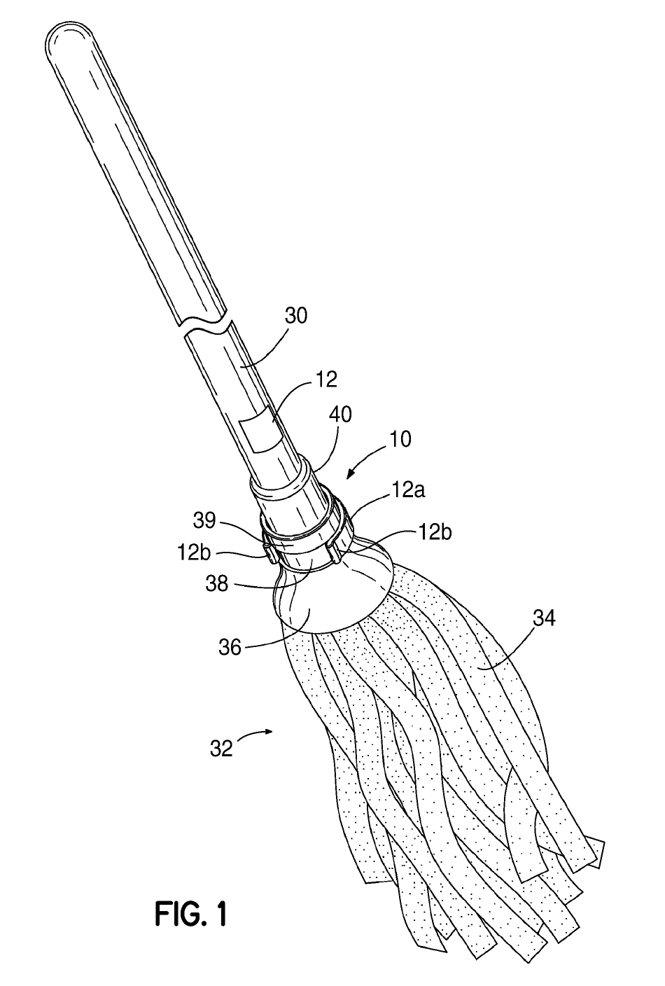

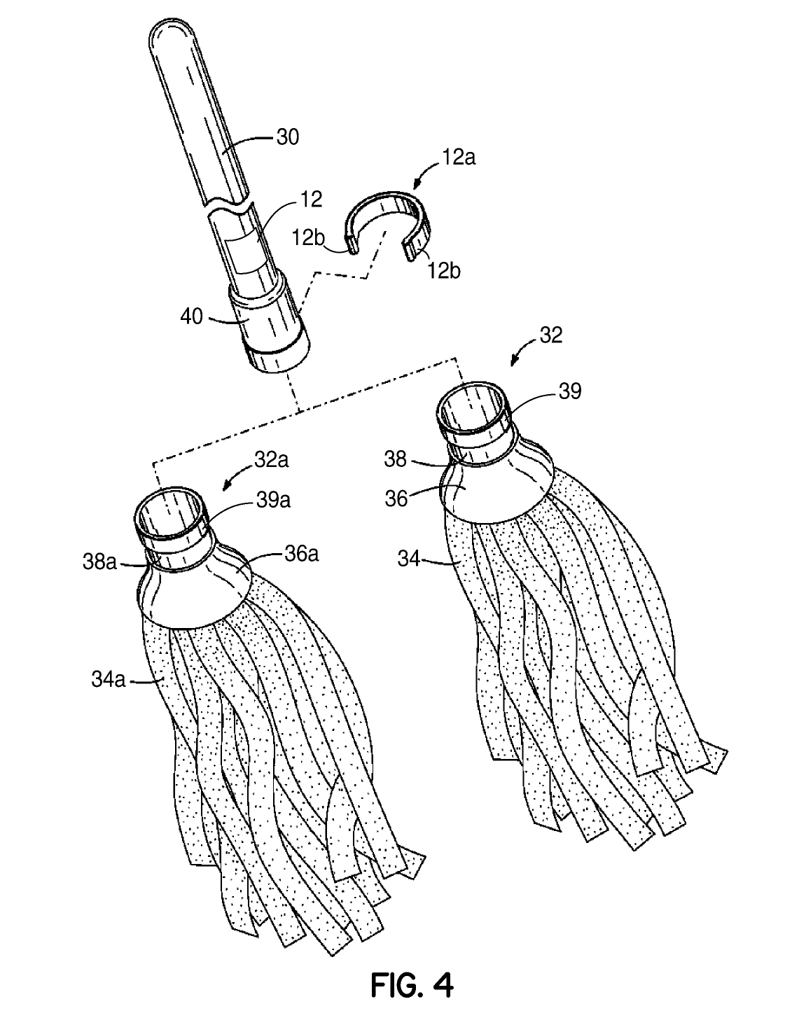

FIG. 1 is a perspective view of an exemplary cleaning tool, such as a mop 10. The mop 10 includes indicia 12 in the form of a specifically colored label or sticker prominently displayed on the mop and in this case on a handle 30 of the mop 10. The mop handle 30 is just one example of a permanent, re-useable work piece according to this invention. For example, the indicia 12 may be red, represented by the vertical line pattern shown in FIG. 3A, to designate that the mop 10 is for use in the restroom zone 28, shown in FIG. 2 with a corresponding vertical line pattern; yellow, represented by the checkered pattern shown in FIG. 3B, for use in the kitchen zone 26, shown in FIG. 2 with a corresponding checkered pattern; or blue, represented by the horizontal line pattern shown in FIG. 3C, for use in the dining zone 24, shown in FIG. 2 with a corresponding horizontal line pattern. The mop 10 designated for use in the welcome zone 16 may include indicia 12 of a fourth color (not shown) corresponding to a fourth color assigned to welcome zone 16, or may be a mop 10 already designed for use in at least one of the other zones, such as the mop 10 with blue indicia 12 for use in the dining zone 24. The indicia 12 may also include an international symbol corresponding to an assigned zone 16, 24, 26, 28. For example, the indicia 12 may illustrate a toilet, as shown in FIG. 3D, which also provides an indication that the mop 10 is to be used in the restroom zone 28. Alternatively or in addition, the indicia 12 may include a textual message in several languages, indicating that the mop 10 is to be used for a designated zone 16, 24, 26, 28. For example, the indicia 12 corresponding to restroom zone 28 may include suitable text in English, Spanish, and French, such as “Restroom,” “Baño,” and “Toilette,” as shown in FIG. 3E. Various other words from these and other appropriate languages may be included on indicia 12 to describe a restroom zone 28 or any other zones, as desired.

Further differentiation may also be desired, such that subzones of environment or restaurant 14 may be designated and additional indicia 12 may be included on mops 10 to further specify which subzones mops 10 are permitted for use in. For example, two mops 10 designated for use in the restroom zone 28 may be differentiated for separate use in a men's restroom and in a women's restroom. This can be accomplished, for example, by providing both mops 10 with the red indicia 12 previously discussed with reference to FIG. 3A, and further providing one of the mops 10 with a textual indicia 12, such as the word “Men” (not shown), and providing the other of the mops 10 with a different textual indicia 12, such as the word “Women” (not shown). In this example, the red indicia 12 may be independent of or incorporated with the textual indicia 12. Any suitable indicia 12 may be used as discussed herein.

In FIG. 1 one exemplary embodiment of a tool in the form of a typical mop 10 for use in a restaurant 14 is shown. The mop 10 may include the colored indicia 12, an international symbol, and a textual message in one or more languages indicating that the mop 10 is to be used for a specific zone.

With reference to FIG. 1, the mop may include a mop head 32 with cloth strands 34 which are secured in conventional fashion to a mop head hub 36 and a mop head connector 38. The mop head 32 is just one example of a non-differentiated replaceable working portion of a tool according to this invention. The mop head connector 38 is adapted to releasably couple to the mop handle 30 which includes a handle connector 40. Handle connector 40 is configured to be inserted into mop head connector 38 via integrated collar 39, such that the mop head 32 and handle 30 are securely and releasably coupled together. Any of a variety of connector designs is readily applicable for releasably connecting the mop handle 30 to the mop head 32, including a threaded connection, frictional connection, locking pin connection, or other arrangements within the scope of this invention. The secure connection provided by mop head connector 38 and the handle connector 40, ensures that the handle 30 to mop head 32 connection of the mop 10 is maintained during use of the mop 10. The mop 10 shown and disclosed herein is exemplary only and this invention is readily utilized with all types of mop technology (cotton string, microfiber string mop, microfiber tube mop, microfiber flat mop, dust mops, etc.) as well as any type of handle to mop attachment scheme, as well as other cleaning implements having a permanent handle portion and a replaceable working portion.

The indicia 12 may take the form of an adhesive label affixed to the mop handle 30, a tag, a clip, a marking, an indentation, a protrusion, or another mechanism on the handle 30 within the scope of this invention. One embodiment of a clip indicium 12a is shown in FIG. 1 in a curvilinear or semi-circular configuration and comprising arms 12b. The clip 12a is resilient, thus permitting arms 12b to be expanded outward and, upon release, to return to their original configuration in secure attachment to the mop handle 30. The clip 12a may include a color, symbol, or other indicator as described with respect to indicia 12.

A plurality of tools is classified into specific categories. In the example with mops, mops 10 are divided by area and function within the restaurant 14. Since intermingling the mops 10 from different zones 16, 24, 26, 28 is not desired for hygienic and sanitation reasons, the categories are selected by the location of where the mops 10 are to be utilized. For example, the categories are divided into restroom 28 usage, kitchen 26 usage, and dining room and welcome area 24, 16 usage.

When it is desired to change mop head 32 of any mop 10, after prolonged use, handle connector 40 is disengaged from the mop head connector 38. The mop head 32 can be laundered and reused, or disposed of. Handle connector 40 can then be coupled to the mop head connector 38a via integrated collar 39a of a second mop head 32a for subsequent use and cleaning operations (FIG. 4). The mop 10 is once again ready for use with a fresh, clean mop head 32a.

The indicia 12 remains on the mop handle 30 thereby maintaining the differentiation of the mop 10 for use in a specified zone 16, 24, 26 or 28 even after the replacement of the mop head 32 with a clean mop head 32a. Advantageously, the mop heads 32, 32a are not differentiated such that any mop head may be coupled to any of the mop handles 30 which are differentiated from each other by the indicia 12 and assigned to the respective zone 16, 24, 26 or 28. As such, the restaurant and/or supply vendor does not need to maintain an inventory of multiple differentiated mop heads 32. The differentiated mop handles 30 may remain in the assigned zone 16, 24, 26, and 28 for cleaning. Alternatively, new or different indicia 12 may be added to the mop handle 30 for re-assignment to a different zone. If the indicium 12 is an adhesive label according to one embodiment of this invention, a new or different color label may be applied over top of the existing label on a repeated basis to utilize the mop handle 30 sequentially in any of the zones 16, 24, 26 or 28 as needed. By providing several types of indicators (color, symbol, text) in coding each mop 10 for a specific task, practically any employee can easily and quickly determine which mop 10 is used for each particular zone 16, 24, 26, 28. Since some employees are color blind, a color coding may not always be helpful. Thus, labeling in several languages may be provided for those employees that are able to read. Additionally, for those employees that cannot read, each mop 10 may also include an international symbol easily understood by most individuals. For example, a symbol of a toilet may be used to indicate that mop 10 is to be used in the restroom zone 28.

After determining the different categories for which each mop 10 is to be used, the mops 10 may be coded with a plurality of indicators providing easy identification to most individuals utilizing the mops 10. A colored label or sticker 12 may be prominently displayed on the mops 10. The colored indicium 12 of each mop 10 is color coded and associated with a specific zone 16, 24, 26, 28. The color coding provides a readily identifiable notice to most people. In the examples described in FIGS. 1-4, the restroom zone is red, the kitchen zone is yellow, and the dining room and welcome area zone is blue. The specific colors are exemplary only and provide but one color scheme embodiment within the scope of this invention.

A textual label written in a number of languages specifying the zone in which each mop 10 belongs may be placed upon each mop 10. For example, a mop 10 for use in the bathroom would include the word for restroom in several languages, such as English, Spanish, and French. A symbol identifying each tool 10 to its associated zone 16, 24, 26, 28 may be applied to the mop 10. The symbol may be a universally recognizable symbol allowing individuals from any country to understand to which zone the mop belongs. For example, in the restroom category, a symbol of a toilet may be used. In the kitchen category, a symbol of a stove may be used. The dining room mop may include a symbol of a table to indicate that the mop is used for cleaning within the dining room.

By providing a number of indications, all employees can easily identify which mop 10 should be used for each specific zone. For those employees who cannot readily identify various colors, other forms of indicators associating the tools 10 to their selected zones may be provided. By labeling the tools 10 in several languages, employees who do not understand English are still able to read the label. Additionally, since many employees cannot read, international symbols provide another easily identifiable indication of the specific category the tool should be used for.

Additionally, numbers, symbols, patterns, and icons may also be used as indicia 12 to identify the tool 10. Indicia 12 may be fully integrated with the handle 30 or may be applied to handle 30 separately. Also, in certain embodiments the indicia 12 may cover the entire handle 30, such as in an exemplary case in which handle 30 is fully colored with red indicia 12. Any coding scheme which provides an indicator to identify and associate the specific tool 10 to the proper zone may be used.

Also, although the mops 10 use a coding scheme located on the lower portion of each mop handle 30, the indicia 12 may be located on other areas of each tool 10. Additionally, the coding scheme may be set to an industry-wide standard. Thus, specific colors, labels and icons may be consistently used and positioned on tools 10 for a particular industry. This standard coding scheme allows employees jumping from one job to another job at a different location to utilize the proper tool for the proper task while avoiding confusion and additional training.

An additional aspect of this invention is to utilize the indicia 12 of a particular zone 16, 24, 26, 28 for ancillary equipment or tools to be used with the tool 10. For example, a mop 10 is often used with a bucket (not shown) which could likewise be assigned to a specific zone and bear the associated indicia 12.

In addition to the usage of the coding scheme on mops 10 in the restaurant industry, the method of identifying tools 10 may also be used for various other items. For example, other cleaning tools, such as dusters, brooms, scrubbers, cleaning supply dispensers, and other cleaning devices which can comprise a permanent handle portion and a replaceable working portion may all include coded indicators providing easy identification of the proper tool 10 for the proper task by individuals while simplifying inventory and supply requirements. Additionally, any other tools 10 having a permanent handle portion and a replaceable working portion may be similarly coded.

The disclosed method has been exemplified for the usage of specific tools within a restaurant 14; however, this method may also be used in other industries. For example, in the medical industry, several tools having permanent handle portions and replaceable working portions must be used for specific tasks or specific patients and not used with other tasks or patients. A patient having a contagious disease that requires the use of a specific medical tool may have a tool having a permanent handle portion including a code indicating that the tool is only to be used for that specific patient or patients with the same exact ailment, thus preventing the spread of the disease to other patients. As discussed above, the coded permanent handle portion includes a plurality of indicators allowing the entire medical staff a simple way of identifying the proper tool for the proper task.

Another industry where this method may be particularly useful is within a manufacturing industry requiring cleanliness standards. During the manufacture of semiconductors, for example, it is imperative that the manufacturing processes are accomplished in a sterile environment. Thus the carriage of particles within a “clean room” where the semiconductors are manufactured must be reduced or eliminated. Typically, specialized tools are sterilized prior to use within the clean room. In addition, various areas of the clean room require additional sterilization procedures. It would be advantageous to code various tools and devices which comprise permanent handle portions and replaceable working portions, and which are allowed to be used within selected areas of the clean room environment with a plurality of indicators identifying the tools and devices as properly being used within the specified areas of the clean room.

From the above disclosure of the general principles of this invention and the preceding detailed description of at least one embodiment, those skilled in the art will readily comprehend the various modifications to which this invention is susceptible. Therefore, I desire to be limited only by the scope of the following claims and equivalents thereof.

I claim:

1. A tool comprising:
a permanent workpiece portion;
a replaceable working portion; and
a group of usage indicating indicia on said permanent workpiece portion that includes a colored indicia, an international symbol, and a textual message to identify an area, zone, and application in which the tool is to be utilized, wherein the colored indicia, the international symbol, and the textual message provides redundant information specifying an intended usage of each permanent workpiece portion.

2. The tool of claim 1 wherein said usage indicating indicia has a configuration and size that are operable to be readily recognized from a distance by an individual supervising an employee using the tool.

3. The tool of claim 1 wherein said at least one usage indicating indicia includes in addition to colored indicia, the international symbol, and the textual message at least one of a pattern, a numeric code, a tactile symbol, a geometric symbol, and a graphical representation, that provides further redundant information specifying the intended usage of each workpiece portion.

4. The tool of claim 1 wherein said usage indicating indicia comprises at least one of an adhesive label, a tag, a clip, a marking, an indentation, and a protrusion.

5. The tool of claim 1 wherein said usage indicating indicia is adapted to represent at least one of a restroom area, a dining area, a kitchen area, and a welcome area.

6. The tool of claim 1 wherein said permanent workpiece portion is a mop handle and said replaceable working portion is a mop head.

7. The tool of claim 1 wherein said tool is a mop utilized to sanitize at least one of a plurality of areas in at least one of a restaurant, a hotel, a healthcare facility, an educational institution, a convenience store, a gas station, and an office building.

8. A supply of tools comprising:
a plurality of permanent workpiece portions with permanent workpiece portion being a member of at least one of at least two groups, wherein each permanent workpiece portion includes at least one group indicating indicia that includes a first colored indicia, a first international symbol, and a first textual message with each of the at least one group indicating indicia provides redundant information specifying an intended usage of each permanent workpiece portion and is associated with at least one of the at least two groups; and
a plurality of non-differentiated replaceable working portions adapted to be selectively and interchangeably coupled to any of said plurality of permanent workpiece portions.

9. The supply of tools of claim 8 wherein said at least one group indicating indicia has a configuration and size that are operable to be readily recognized from a distance by an individual supervising an employee using the tool.

10. The supply of tools of claim 8 wherein said at least one group indicating indicia in addition to the colored indicia, the international symbol, and the textual message includes at least one of a pattern, a numeric code, a tactile symbol, a geometric symbol, and a graphical representation that provides further redundant information specifying the intended usage of each workpiece portion.

11. The supply of tools of claim 8 wherein said at least one group indicating indicia comprises at least one of an adhesive label, a tag, a clip, a marking, an indentation, and a protrusion.

12. The supply of tools of claim 8 wherein said at least one group indicating indicia is adapted to represent at least one of a restroom area, a dining area, a kitchen area, and a welcome area.

13. The supply of tools of claim 8 wherein at least one of said plurality of permanent workpiece portions is a mop handle and at least one of said plurality of non-differentiated replaceable working portions is a mop head.

14. The supply of tools of claim 8 wherein at least one of the tools is a mop utilized to sanitize at least one of a plurality of areas in at least one of a restaurant, a hotel, a healthcare facility, an educational institution, a convenience store, a gas station, and an office building.

15. A system for managing an inventory of tools, wherein each tool comprises a permanent workpiece portion and a replaceable working portion, comprising:
a first inventory of permanent workpiece portions, wherein each permanent workpiece portion of the first inventory includes a first group indicating indicia that includes a first colored indicia, a first international symbol, and a first textual message, wherein each of the first group of indicating indicia provides redundant information specifying an intended usage of each permanent workpiece portion of the first inventory to increase a likelihood that an individual understands the intended usage;
at least one second inventory of permanent workpiece portions, wherein each permanent workpiece portion of the at least one second inventory includes a second group indicating indicia that includes a second colored indicia, a second international symbol, and a second textual message, wherein each of the second group of indicating indicia provides redundant information specifying an intended usage of each permanent workpiece portion of the second inventory to increase a likelihood that an individual understands the intended usage; and
an inventory of a plurality of non-differentiated replaceable working portions each adapted to be selectively and interchangeably coupled to any of the permanent workpiece portions.

16. The system of claim 15, wherein at least one of said at least one first group indicating indicia and said at least one second group indicating indicia is adapted to represent at least one of a restroom area, a dining area, a kitchen area, and a welcome area.

17. The system of claim 15, wherein said at least one first permanent workpiece portion and said at least one second permanent workpiece portion are constructed of at least one of a similar shape, similar design, and similar material, such that said at least one first permanent workpiece portion and said at least one second permanent workpiece portion are not readily distinguishable in the absence of said at least one first group indicating indicia and said at least one second group indicating indicia.

18. The system of claim 15, wherein at least one of said at least one first group indicating indicia and said at least one second group indicating indicia has a configuration and size that are operable to be readily recognized from a distance by an individual supervising an employee using a tool.

19. The system of claim 15, wherein at least one of said at least one first group indicating indicia and said at least one second group indicating indicia in addition to the colored indicia, the international symbol, and the textual message includes at least one of a pattern, a numeric code, a tactile symbol, a geometric symbol, and a graphical representation that provides further redundant information specifying the intended usage of each workpiece portion.

21. The system of claim 15, wherein at least one of said at least one first group indicating indicia and said at least one second group indicating indicia comprises at least one of an adhesive label, a tag, a clip, a marking, an indentation, and a protrusion.

22. The system of claim 15, wherein said at least one first permanent workpiece portion and said at least one second permanent workpiece portion are mop handles and said replaceable working portions are mop heads.

23. A system for cleaning a plurality of discrete zones using a plurality of differentiated cleaning tools, comprising:
a first cleaning tool comprising a first permanent workpiece portion releasably coupled to a replaceable working portion, wherein said first permanent workpiece portion includes a first colored indicia, a first international symbol, and a first textual message that provides redundant information specifying a first zone assigned to the first cleaning tool that the first permanent workpiece portion is intended to be used to increase a likelihood that an individual understands that the first cleaning tool is intended to be used in the first zone;
at least one second cleaning tool comprising at least one second permanent workpiece portion releasably coupled to at least one replaceable working portion, wherein said at least one second permanent workpiece portion includes a second colored indicia, a second international symbol, and a second textual message that provides redundant information specifying a second zone assigned to the at least one second cleaning tool that the at least one second cleaning tool is intended to be used to increase a likelihood that an individual understands that the at least one second cleaning tool is intended to be used in the second zone.
